(19) United States
(12) Patent Application Publication
(10) Pub. No.: US 2013/0233780 A1
(43) Pub. Date: Sep. 12, 2013

(54) ULTRATHIN-LAYER CHROMATOGRAPHY PLATES COMPRISING ELECTROSPUN FIBERS AND METHODS OF MAKING AND USING THE SAME

(71) Applicants: Susan Olesik, Columbus, OH (US); Michael Beilke, Columbus, OH (US); Jonathan Clark, Columbus, OH (US); Joseph Zewe, Columbus, OH (US)

(72) Inventors: Susan Olesik, Columbus, OH (US); Michael Beilke, Columbus, OH (US); Jonathan Clark, Columbus, OH (US); Joseph Zewe, Columbus, OH (US)

(21) Appl. No.: 13/796,611

(22) Filed: Mar. 12, 2013

Related U.S. Application Data
(60) Provisional application No. 61/609,612, filed on Mar. 12, 2012.

(51) Int. Cl. G01N 30/94

(52) U.S. Cl. CPC G01N 30/94
USPC 210/198.3; 264/8

(57) ABSTRACT

An ultrathin-layer chromatography plate including a stationary phase comprising electrospun nanofibers wherein at least about 50% of the nanofibers are oriented within 20° of a direction of alignment, and wherein the stationary phase has a thickness from about 10 μm to about 30 μm.

### CROSS-REFERENCE TO RELATED APPLICATIONS

This application claims priority to U.S. Provisional Patent Application No. 61/609,612, filed Mar. 12, 2012, which is incorporated herein in its entirety by reference.

### STATEMENT REGARDING FEDERALLY-SPONSORED RESEARCH

The present invention was made with Government support under at least one of the following grants awarded by U.S. National Science Foundation: Grant #0914790: Nanoscale Science and Engineering Center (NSEC) for Affordable Nanoengineering of Polymeric Biomedical Devices, and U.S. National Science Foundation: Grant #1012279 Toward Homogeneous Carbon Media for Separation Science. The United States Government may have certain rights to this invention under 35 U.S. §200 et seq.

### BACKGROUND

Originally developed in the 1950s, thin layer chromatography (TLC), also called planar chromatography, is widely used today in environmental analysis, food, clinical, and pharmaceutical industries. See, C. F. Poole, The Essence of Chromatography, Elsevier Science, Amsterdam, The Netherlands, 2003; and J. Sherma, Anal. Chem. 82 (2010) 4895-4910, each of which is incorporated herein in its entirety by reference. The stationary phase in TLC consists of sorbent particles that are attached to a solid support, typically an aluminum or glass plate. The analytes of interest are spotted directly onto the stationary phase, the edge of which is brought into contact with the mobile phase. The mobile phase proceeds up the plate via capillary action. Separation of analytes occurs due to interactions with both the mobile phase and the stationary phase. A number of different materials have been applied as the stationary phase in TLC, including alumina, cellulose, ion-exchange resins and, perhaps most commonly, silica gel. See, J. S. Bernard Fried, Thin-layer Chromatography: Techniques and Applications, Marcel Dekker, New York, N.Y., 1994; L. W. Bezuidenhout, M. J. Brett, J. Chromatogr. A. 1183 (2008) 179-185; S. A. Nabi, M. A. Khan, Acta Chromatogr. 13 (2003) 161-171; and M. Macan-Kastelan, S. Cerjan-Stefanovic, A. Petrovic, Chromatographia, 27 (1989) 297-300, each of which is incorporated herein in its entirety by reference. More recently, nanostructured surfaces have been developed for TLC applications. See, J. Song, D. S. Jensen, D. N. Hutchison, B. Turner, T. Wood, A. Dadson, M. A. Vail, M. R. Linford, R. R. Vanfleet, R. C. Davis, Adv. Funct. Mater. 21 (2011) 1132-1139; and S. R. Jim, A. J. Oka, M. T. Taschuk, M. J. Brett, J. Chromatogr. A. 1218 (2011) 7203-7210, each of which is incorporated herein in its entirety by reference.

In 2001, ultra-thin layer chromatography (UTLC) was developed. This technology, which typically utilizes a stationary phase with a 5-30 μm thickness (compared to 100-400 μm thick stationary phases for commercial TLC devices), represented a significant improvement in analysis time and sensitivity over traditional TLC devices. See, Bezuidenhout et al. (2008); and H. E. Hauck, M. Schulz, Chromatographia Suppl. 57 (2003) S-313-S-315, which is incorporated herein in its entirety by reference. For some UTLC plates, electrospinning may be utilized to generate a mat of nanofibers that can be used as a UTLC sorbent. See, J. E. Clark, S. V. Olesik, Anal. Chem. 81 (2009) 4121-4130; J. E. Clark, S. V. Olesik, J. Chromatogr. A. 1217 (2010) 4655-4662; and U.S. Patent Application Pub. No. 2011/0214487, each of which is incorporated herein in its entirety by reference. Electrospinning is a cost effective method of generating nanofibers that includes placing a high electric field between a syringe containing a polymeric solution and a conductive surface. At a critical voltage, the surface tension of the polymer solution at the syringe tip is overcome, and polymeric nanofibers are splayed from the droplet and are collected on the conductive surface. See, S. Ramakrishna, K. Fujihara, W. E. Teo, T. C. Lim, Z. Ma, An Introduction to Electrospinning and Nanofibers, World Scientific, River Edge, N.J., 2005, which is incorporated herein in its entirety by reference. To date, electrospinning has been used in a variety of applications including use in sensors, tissue scaffolds, and in solid phase microextraction. See, W. G. Shim, C. Kim, J. W. Lee, J. J. Yun, Y. Jeong, H. Moon, K. S. Yang, J. Appl. Polym. Sci. 102 (2006) 2454-2462; U. Boudriot, R. Dersch, A. Greiner, J. H. Wendorff, Artif. Organs. 30 (2006) 785-792; J. W. Zewe, J. K. Steach, S. V. Olesik, Anal. Chem. 82 (2010) 5341-5348; and T. E. Newsome, J. W. Zewe, S. V. Olesik, J. Chromatogr. A. 1262 (2012) 1-7, each of which is incorporated herein in its entirety by reference.

Electrospun UTLC (E-UTLC) plates are particularly attractive for a number of reasons: no binder material is required in fabrication (see, Sherma (2010)); the solid support and mat thickness are readily variable; the small dimensions of the fibers provide a support with high surface area, and the chemical functionalities in the stationary phase can be easily modified. See, Clark (2009) and Clark (2010). Electrospun polyacrylonitrile (PAN) UTLC plates not only demonstrated a decreased time of analysis, but also vastly superior separation efficiencies for steroidal compounds relative to a commercially available cyano phase TLC plate. See, Clark (2009). Cyano-modified phases are frequently utilized as a stationary phase in the separation of steroidal compounds, as well as alkaloids and derivitized amino acids. See, W. Jost, H. E. Hauck, W. Fischer, Chromatographia, 21 (1986) 375-378, which is incorporated herein in its entirety by reference. The PAN E-UTLC plate demonstrated 500 times greater separation efficiency and a decreased time of analysis by up to 50% when compared to the conventional cyano TLC phase. See, Clark (2009).

As described, the separation techniques of TLC have known impediments.

### SUMMARY

This disclosure provides ultrathin-layer chromatography plates including a stationary phase comprising electrospun nanofibers. At least about 50% of the nanofibers may be oriented within 20° of a direction of alignment. The stationary phase may have a thickness from about 10 μm to about 30 μm.

This disclosure also provides methods of making ultrathin-layer chromatography plates, the methods comprising: rotating an electrospinning target; and electrospinning a solution comprising a polymer to form the stationary phase comprising polymer nanofibers. At least about 50% of the nanofibers may be oriented within 20° of a direction of alignment. The stationary phase may have a thickness from about 10 μm to about 30 μm.

Other aspect of the invention will become apparent by consideration of the detailed description and accompanying drawings.

### BRIEF DESCRIPTION OF THE DRAWINGS

FIG. 1 is a picture of the apparatus utilized in preparing the aligned electrospun PAN nanofibers prepared in the Examples. The drum is contained within a Plexiglass box which serves to isolate the electrospun nanofibers from the outside environment while acting as a safe guard against mandrel failure.

FIG. 2 shows SEM images illustrating aligned electrospun PAN nanofibers generated on the rotating collector at rotational speeds of (A) 500 (B) 750 (C) 1000 (D) 1250 and (E) 1500 rpm. The white bar demonstrates the direction in which the drum was rotated; this also serves as the direction of nanofiber alignment.

FIG. 3 is a chart showing the percentage of electrospun PAN nanofibers positioned within a 10°, 20°, and 30° angle from the direction of nanofiber alignment for nanofibrous mats generated at 500 (left-most bar in each grouping of five), 750 (second bar from left in each grouping of five), 1000 (center bar in each grouping of five), 1250 (second bar from right in each grouping of five), and 1500 rpm (right-most bar in grouping of five).

FIG. 4 is a chart showing the retardation factors of acebutolol (diamond—♦), cortisone (square—▪), and propranolol (triangle—▴) for PAN (A) AE-UTLC plates and (B) E-UTLC plates (n=5).

FIG. 5 is a chart showing the time of analysis as a function of mobile phase composition for PAN AE-UTLC (square—▪) and nonaligned E-UTLC (diamond—♦). The migration distance was 2.5 cm.

FIG. 6 shows chromatograms for the separation of (1) acebutolol, (2) cortisone, and (3) propranolol on a PAN (A) AE-UTLC plate using a 40:60 chloroform:heptane mobile phase with 1% TBABr and on a (B) E-UTLC plate using 30:70 chloroform:heptane mobile phase with 1% TBABr.

FIG. 7 is a chart plotting the change in efficiency, N, of propranolol with increasing migration distance using a 40:60 chloroform:heptane (1% TBABr) mobile phase and PAN AE-UTLC plate.

FIG. 8 is a chart showing a comparison of mobile phase velocities of PAN AE-UTLC (square—▪) plates, PAN E-UTLC (diamond—♦) plates, and commercial cyano TLC (triangle—▴) plates using heptane as the mobile phase. Error bars are contained within data points when not visible.

FIG. 9 is an illustration of the (A) parallel electrode and (B) rotating drum aligned electrospinning apparatuses.

FIG. 10 is a chart showing mat thickness as a function of electrospinning time for the generation of aligned electrospun PAN nanofibers.

FIG. 11 is a chart showing mat thickness (A) and fiber morphology (B) of the aligned electrospun PAN nanofibers collected for 120 minutes at 1250 rpm.

FIG. 12 is a chart showing a comparison of mobile phase velocities of PAN AE-UTLC (square—▪) plates, PAN E-UTLC (diamond—♦) plates, and commercial cyano TLC (triangle—▴) plates using (A) 50:50 acetone:water and (B) acetone as mobile phases. Error bars are contained within data points when not visible.

### DETAILED DESCRIPTION

This disclosure is not limited in its application to the details of construction and the arrangement of components set forth in the following description. The disclosure may provide other embodiments and may be practiced or carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

It should be understood that, as used herein, the term “about” is synonymous with the term “approximately.” Illustratively, the use of the term “about” indicates that a value includes values slightly outside the cited values. Variation may be due to conditions such as experimental error, manufacturing tolerances, variations in equilibrium conditions, and the like. In some embodiments, the term “about” includes the cited value plus or minus 10%. In all cases, where the term “about” has been used to describe a value, it should be appreciated that this disclosure also supports the exact value.

To the extent that they complement the specification and are enabling of the disclosed embodiments, the following publications are each incorporated herein in their entirety by reference: The Doctoral Dissertation of Jeremy Steach entitled: The Development of Novel Phases with Photoresist for Capillary Electrophoresis, Capillary Electrochromatography, and Solid-Phase Microextraction, available at the Ohio State University; Master's Thesis of Joseph W. Zewe, Electrospun Fibers for Solid Phase Extraction, 2010, available at the Ohio State University; Newsome, Toni, E., Zewe, Joseph, W., Olesik, Susan V., “Electrospun nanofibrous solid-phase microextraction coatings for preconcentration of pharmaceuticals prior to liquid chromatographic separations,” Journal of Chromatography A (2012), 1262, 1-7; Lu, Tian; Olesik, Susan V., Polyvinyl alcohol ultra-thin layer chromatography of amino acids, Journal of Chromatography, B: 2013, 912, 98-104; and Beilke, Michael E., Zewe, Joseph W., Clark, Jonathan E., and Olesik, Susan V., “Aligned Electrospun Nanofibers for Ultra-thin Layer Chromatography,” Analytica Chimica Acta, (2013), 761, 201-208.

The previous E-UTLC studies used electrospun mats with randomly oriented nanofibers. The work reported herein marks the first use of aligned electrospun UTLC (AE-UTLC). Aligned electrospun fibers have been utilized in a variety of applications, often demonstrating a profound impact due to the ordered structuring of the nanofibers. See, W. E. Teo, S. Ramakrishna, Nanotechnology, 17 (2006) R89-R106, which is incorporated herein in its entirety by reference. For example, aligned nanofibers have been utilized as cell scaffolds. With this fiber configuration, cells propagate in the direction of the nanofibers' orientation. See, C. Y. Xu, R. Inai, M. Kotaki, S. Ramakrishna, Biomater. 25 (2004) 877-886, which is incorporated herein in its entirety by reference. It was hypothesized that UTLC with aligned electrospun nanofibers may show an increase in chromatographic performance relative to non-aligned electrospun UTLC plates.

While there are many different techniques that have been applied to generate aligned electrospun fibers (see, Z. Song, X. Hou, L. Zhang, S. Wu, Materials, 4 (2011) 621-632, which is incorporated herein in its entirety by reference), the two most commonly used models are: the parallel electrode and rotating drum models (FIG. 51). See, Teo (2006). While the parallel electrode model is both simple to use and capable of generating highly aligned nanofibers, the electrodes can only be placed about 1-5 cm apart, thus limiting the length of the nanofibrous mat that can be generated. See, Teo (2006); and R. Jalili, M. Morshed, S. A. H. Ravandi, J. Appl. Polym. Sci. 101 (2006) 4350-4357, which is incorporated herein in its entirety by reference. Furthermore, it is very difficult to obtain electrospun mats that are sufficiently thick to use as a chromatographic support; the wider the distance between the two electrodes the thinner the electrospun mat. See, Teo (2006); and D. Li, Y. Wang, Y. Xia, Nano Lett. 3 (2003) 1167-1171, which is incorporated herein in its entirety by reference.

A rotating drum apparatus is capable of giving much larger surface areas of aligned nanofibers than the parallel electrode configuration. See, Teo (2006); S. F. Fennessey, R. J. Farris, Polymer, 45 (2004) 4217-4225; and W. Hu, Z. Huang, S. Meng, C. He, J. Mater. Sci.: Mater. Med. 20 (2009) 2275-2284, each of which is incorporated herein in its entirety by reference. Thicker nanofibrous mats are also possible with the rotating drum. However, it is more challenging to generate mats that are as highly aligned as those generated with parallel electrodes. Additionally, the rotational speed must be optimized to produce the highest alignment possible while preventing fiber breakage. See, Teo (2006). Due to the increased mat areas and thicknesses possible with the rotating drum, the AE-UTLC plates utilized in this study were fabricated using this method.

This disclosure provides ultrathin-layer chromatography plates and methods of making and using ultrathin-layer chromatography plates, as described in detail below.

### I. Ultrathin-Layer Chromatography Plates

This disclosure provides ultrathin-layer chromatography plates including a stationary phase comprising electrospun nanofibers, wherein the stationary phase has a thickness from about 10 μm to about 30 μm.

The UTLC plates disclosed herein may comprise a stationary phase having a thickness of at least about 10 μm, such as at least about 11 μm, at least about 12 μm, at least about 13 μm, at least about 14 μm, at least about 15 μm, at least about 16 μm, at least about 17 μm, at least about 18 μm, at least about 19 μm, at least about 20 μm, at least about 21 μm, at least about 22 μm, at least about 23 μm, at least about 24 μm, at least about 25 μm, at least about 26 μm, at least about 27 μm, at least about 28 μm, or at least about 29 μm. The UTLC plates disclosed herein may comprise a stationary phase having a thickness of at most about 30 μm, such as at most about 29 μm, at most about 28 μm, at most about 27 μm, at most about 26 μm, at most about 25 μm, at most about 24 μm, at most about 23 μm, at most about 22 μm, at most about 21 μm, at most about 20 μm, at most about 19 μm, at most about 18 μm, at most about 17 μm, at most about 16 μm, at most about 15 μm, at most about 14 μm, at most about 13 μm, at most about 12 μm, or at most about 11 μm. This includes embodiments where the stationary phase thickness ranges from about 10 μm to about 30 μm, including, but not limited to, ranges from about 12.5 μm to about 27.5 μm, and from about 15 μm to about 25 μm.

In some embodiments, the UTLC plate may comprise a direction of alignment. In some embodiments, the direction of alignment may be aligned with the direction of motion of the external surface of the electrospinning target during rotation of the target. In preferred embodiments, the direction of alignment may be the same as the direction of propagation of the mobile phase.

The UTLC plates disclosed herein may have an average effective pore radius of at least about 1.00 μm, such as at least about 1.05 μm, at least about 1.10 μm, at least about 1.15 μm, at least about 1.20 μm, at least about 1.25 μm, at least about 1.30 μm, at least about 1.35 μm, at least about 1.40 μm, at least about 1.45 μm, at least about 1.50 μm, at least about 1.55 μm, at least about 1.60 μm, at least about 1.65 μm, at least about 1.70 μm, at least about 1.75 μm, at least about 1.80 μm, at least about 1.85 μm, at least about 1.90 μm, at least about 1.95 μm, or at least about 2.00 μm. The UTLC plates disclosed herein may have an average effective pore radius of at most about 2.00 μm, such as at most about 1.95 μm, at most about 1.90 μm, at most about 1.85 μm, at most about 1.80 μm, at most about 1.75 μm, at most about 1.70 μm, at most about 1.65 μm, at most about 1.60 μm, at most about 1.55 μm, at most about 1.50 μm, at most about 1.45 μm, at most about 1.40 μm, at most about 1.35 μm, at most about 1.30 μm, at most about 1.25 μm, at most about 1.20 μm, at most about 1.15 μm, at most about 1.10 μm, or at most about 1.05 μm. This includes embodiments where the average effective pore radius ranges from about 1.00 μm to about 2.00 μm, including, but not limited to, ranges from about 1.10 μm to about 1.75 μm, and from about 1.20 μm to about 1.50 μm.

The UTLC plate disclosed herein may comprise a stationary phase having a length and a width. In some embodiments, the UTLC plate may comprise a stationary phase having a thickness that is substantially consistent along its entire length and width.

Electrospun Nanofibers

The ultrathin-layer chromatography plates disclosed herein may include a stationary phase comprising electrospun nanofibers.

In principle, the electrospun nanofibers may comprise any polymer that is suitable for electrospinning, such as any polymer having suitably high molecular weight and viscosity. In some embodiments, the electrospun nanofibers may comprise a polymer selected from the group consisting of polyacrylonitrile, polyvinyl alcohol, polyacrylamide, poly(methyl methacrylate), polyethylene oxide, polyvinylpyrrolidone, sodium polystyrene sulfonate, polyhydroxyalkanoate, polystyrene, SU-8 photoresist, nylon, and combinations thereof.

The UTLC plates disclosed herein may include a stationary phase comprising electrospun nanofibers having an average diameter of at least about 100 nm, such as at least about 150 nm, at least about 200 nm, at least about 225 nm, at least about 250 nm, at least about 275 nm, at least about 300 nm, at least about 310 nm, at least about 320 nm, at least about 330 nm, at least about 340 nm, at least about 350 nm, at least about 360 nm, at least about 370 nm, at least about 380 nm, at least about 390 nm, at least about 400 nm, at least about 410 nm, at least about 420 nm, at least about 430 nm, at least about 440 nm, at least about 450 nm, at least about 460 nm, at least about 470 nm, at least about 480 nm, at least about 490 nm, at least about 500 nm, at least about 510 nm, at least about 520 nm, at least about 530 nm, at least about 540 nm, at least about 550 nm, at least about 560 nm, at least about 570 nm, at least about 580 nm, at least about 590 nm, at least about 600 nm, at least about 625 nm, at least about 650 nm, at least about 675 nm, at least about 700 nm, at least about 750 nm, at least about 800 nm, at least about 850 nm, at least about 900 nm, at least about 950 nm, at least about 1000 nm, at least about 1.25 μm, at least about 1.5 μm, or at least about 1.75 μm. The UTLC plates disclosed herein may include a stationary phase comprising electrospun nanofibers having an average diameter of at most about 2 μm, at most about 1.75 μm, at most about 1.5 μm, at most about 1.25 μm, at most about 1000 nm, at most about 900 nm, at most about 800 nm, at most about 700 nm, at most about 600 nm, at most about 590 nm, at most about 580 nm, at most about 570 nm, at most about 560 nm, at most about 550 nm, at most about 540 nm, at most about 530 nm, at most about 520 nm, at most about 510 nm, at most about 500 nm, at most about 490 nm, at most about 480 nm, at most about 470 nm, at most about 460 nm, at most about 450 nm, at most about 440 nm, at most about 430 nm, at most about 420 nm, at most about 410 nm, at most about 400 nm, at most about 390 nm, at most about 380 nm, at most about 370 nm, at most about 360 nm, at most about 350 nm, at most about 340 nm, at most about 330 nm, at most about 320 nm, at most about 310 nm, at most about 300 nm, at most about 275 nm, at most about 250 nm, at most about 225 nm, at most about 200 nm, at most about 175 nm, at most about 150 nm, or at most about 125 nm. This includes embodiments where the electrospun nanofibers have an average diameter ranging from about 100 nm to about 2 μm, including, but not limited to, an average diameter ranging from about 250 nm to about 750 nm, and from about 300 nm to about 500 nm.

In some embodiments, the UTLC plates may include a stationary phase comprising electrospun nanofibers wherein at least about 40% of the nanofibers are oriented within 10° of the direction of alignment, such as at least about 41%, at least about 42%, at least about 43%, at least about 44%, at least about 45%, at least about 46%, at least about 47%, at least about 48%, at least about 49%, at least about 50%, at least about 51%, at least about 52%, at least about 53%, at least about 54%, at least about 55%, at least about 56%, at least about 57%, at least about 58%, at least about 59%, at least about 60%, at least about 61%, at least about 62%, at least about 63%, at least about 64%, at least about 65%, at least about 66%, at least about 67%, at least about 68%, at least about 69%, at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99% or the nanofibers are oriented within 10° of the direction of alignment.

In some embodiments, the UTLC plates may include a stationary phase comprising electrospun nanofibers wherein at least about 50% of the nanofibers are oriented within 20° of the direction of alignment, such as at least about 51%, at least about 52%, at least about 53%, at least about 54%, at least about 55%, at least about 56%, at least about 57%, at least about 58%, at least about 59%, at least about 60%, at least about 61%, at least about 62%, at least about 63%, at least about 64%, at least about 65%, at least about 66%, at least about 67%, at least about 68%, at least about 69%, at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99% or the nanofibers are oriented within 20° of the direction of alignment.

In some embodiments, the UTLC plates described herein may include a stationary phase comprising electrospun nanofibers wherein at least about 60% of the nanofibers are oriented within 30° of the direction of alignment, such as at least about 61%, at least about 62%, at least about 63%, at least about 64%, at least about 65%, at least about 66%, at least about 67%, at least about 68%, at least about 69%, at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99% or the nanofibers are oriented within 30° of the direction of alignment.

Mobile Phase Velocity Constant

In some embodiments, the UTLC plates disclosed herein may have a mobile phase velocity constant that is greater than those achievable by commercially-available UTLC plates and UTLC plates having a stationary phase comprising electrospun nanofibers that are not aligned in the fashion described herein.

In some embodiments, the UTLC plates may have a mobile phase velocity constant that is greater than a mobile phase velocity constant for commercially-available UTLC plates, wherein the mobile phase is selected from the group consisting of water, acetone, heptane, perfluoroalkane, hexane, pentane, chloroform, carbon tetrachloride, benzene, toluene, dichloromethane, diethyl ether, ethyl acetate, acetone, acetonitrile, t-butyl alcohol, isoamyl alcohol, 2-propanol, n-butanol, ethyl alcohol, methanol, dimethylformamide, dimethyl sulfoxide, cyclohexane, cyclopentanone, triethylamine, acetic acid, formic acid, and combinations thereof.

The UTLC plates disclosed herein may have a mobile phase velocity constant of at least about 0.100 cm²s⁻¹ for heptane as mobile phase, such as at least about 0.105 cm²s⁻¹, at least about 0.110 cm²s⁻¹, at least about 0.115 cm²s⁻¹, at least about 0.120 cm²s⁻¹, at least about 0.125 cm²s⁻¹, at least about 0.130 cm²s⁻¹, at least about 0.135 cm²s⁻¹, at least about 0.140 cm²s⁻¹, at least about 0.145 cm²ₛ⁻¹, at least about 0.150 cm²s⁻¹, at least about 0.155 cm²s⁻¹, at least about 0.160 cm²s⁻¹, at least about 0.165 cm²s⁻¹, at least about 0.170 cm²s⁻¹, at least about 0.175 cm²s⁻¹, at least about 0.180 cm²s⁻¹, at least about 0.185 cm²s⁻¹, at least about 0.190 cm²s⁻¹, at least about 0.195 cm²s⁻¹, or at least about 0.200 cm²s⁻¹, for heptane as mobile phase.

The UTLC plates disclosed herein may have a mobile phase velocity constant of at least about 0.050 cm²s⁻¹ for a 50:50 mixture of acetone and water as mobile phase, such as at least about 0.055 cm²s⁻¹, at least about 0.060 cm²s⁻¹, at least about 0.065 cm²s⁻¹, at least about 0.070 cm²s⁻¹, at least about 0.075 cm²s⁻¹, at least about 0.080 cm²s⁻¹, at least about 0.085 cm²s⁻¹, at least about 0.090 cm²s⁻¹, at least about 0.095 cm²s⁻¹, at least about 0.100 cm²s⁻¹, at least about 0.105 cm²s⁻¹, at least about 0.110 cm²s⁻¹, at least about 0.115 cm²s⁻¹, at least about 0.120 cm²s⁻¹, at least about 0.125 cm²s⁻¹, at least about 0.130 cm²s⁻¹, at least about 0.135 cm²s⁻¹, at least about 0.140 cm²s⁻¹, at least about 0.145 cm²s⁻¹, at least about 0.150 cm²s⁻¹, at least about 0.155 cm²s⁻¹, at least about 0.160 cm²s⁻¹, at least about 0.165 cm²s⁻¹, at least about 0.170 cm²s⁻¹, at least about 0.175 cm²s⁻¹, at least about 0.180 cm²s⁻¹, at least about 0.185 cm²s⁻¹, at least about 0.190 cm²s⁻¹, at least about 0.195 cm²s⁻¹, or at least about 0.200 cm²s⁻¹, for a 50:50 mixture of acetone and water as mobile phase.

The UTLC plates disclosed herein may have a mobile phase velocity constant of at least about 0.100 cm²s⁻¹ for acetone as mobile phase, such as at least about 0.105 cm²s⁻¹, at least about 0.110 cm ²s⁻¹, at least about 0.115 cm²s⁻¹, at least about 0.120 cm²s⁻¹, at least about 0.125 cm²s⁻¹, at least about 0.130 cm²s⁻¹, at least about 0.135 cm²s⁻¹, at least about 0.140 cm²s⁻¹, at least about 0.145 cm²s⁻¹, at least about 0.150 cm²s⁻¹, at least about 0.155 cm²s⁻¹, at least about 0.160 cm²s⁻¹, at least about 0.165 cm²s⁻¹, at least about 0.170 cm²s⁻¹, at least about 0.175 cm²s⁻¹, at least about 0.180 cm²s⁻¹, at least about 0.185 cm²s⁻¹, at least about 0.190 cm²s⁻¹, at least about 0.195 cm²s⁻¹, or at least about 0.200 cm²s⁻¹, for acetone as mobile phase.

In some embodiments, the mobile phase velocity constant is measured along the direction of alignment.

### II. Methods of Making Ultrathin-laver Chromatography Plates

This disclosure provides methods of making an ultrathin-layer chromatography plate including a stationary phase comprising electrospun nanofibers. In some embodiments, the method may comprise rotating an electrospinning target having a substantially circular shape, and electrospinning a solution comprising a polymer to form the stationary phase comprising polymer nanofibers.

Rotating an Electrospinning Target

In principle, the electrospinning target is placed into motion in any fashion suitable such that a surface of the target is moving at a velocity that is matched to the velocity at which fibers are being electrospun.

In some embodiments, the electrospinning target may have any shape suitable for producing aligned electrospun nanofibers. In preferred embodiments, the electrospinning target may have a substantially rectangular shape. In preferred embodiments, the electrospinning target may have a substantially cylindrical structure. In preferred embodiments, the electrospinning target has a substantially rectangular shape and is mounted to the rounded surface of a rotating drum to form a cylindrical structure, such that the target has an external surface moving tangent to the rotating drum cylinder and along the direction of alignment.

In principle, the electrospinning target may comprise any electrically conductive material. In some embodiments, the electrospinning target may comprise a material selected from the group consisting of aluminum, steel, silicon, conductive glass plate, and combinations thereof.

In some embodiments, the electrospinning target may have an external surface. In some embodiments, the external surface of the electrospinning target may be moving at a velocity of at least about 1 m/s, such as at least about 2 m/s, at least about 3 m/s, at least about 4 m/s, at least about 5 m/s, at least about 6 m/s, at least about 7 m/s, at least about 8 m/s, at least about 9 m/s, at least about 10 m/s, at least about 11 m/s, at least about 12 m/s, at least about 13 m/s, at least about 14 m/s, at least about 15 m/s, at least about 16 m/s, at least about 17 m/s, at least about 18 m/s, at least about 19 m/s, at least about 20 m/s, at least about 21 m/s, at least about 22 m/s, at least about 23 m/s, at least about 24 m/s, at least about 25 m/s, at least about 26 m/s, at least about 27 m/s, at least about 28 m/s, at least about 29 m/s, at least about 30 m/s, at least about 31 m/s, at least about 32 m/s, at least about 33 m/s, at least about 34 m/s, at least about 35 m/s, at least about 36 m/s, at least about 37 m/s, at least about 38 m/s, at least about 39 m/s, at least about 40 m/s, at least about 41 m/s, at least about 42 m/s, at least about 43 m/s, at least about 44 m/s, at least about 45 m/s, at least about 46 m/s, at least about 47 m/s, at least about 48 m/s, or at least about 49 m/s. In some embodiments, the external surface of the electrospinning target may be moving at a velocity of at most about 50 m/s, such as at most about 49 m/s, at most about 48 m/s, at most about 47 m/s, at most about 46 m/s, at most about 45 m/s, at most about 44 m/s, at most about 43 m/s, at most about 42 m/s, at most about 41 m/s, at most about 40 m/s, at most about 39 m/s, at most about 38 m/s, at most about 37 m/s, at most about 36 m/s, at most about 35 m/s, at most about 34 m/s, at most about 33 m/s, at most about 32 m/s, at most about 31 m/s, at most about 30 m/s, at most about 29 m/s, at most about 28 m/s, at most about 27 m/s, at most about 26 m/s, at most about 25 m/s, at most about 24 m/s, at most about 23 m/s, at most about 22 m/s, at most about 21 m/s, at most about 20 m/s, at most about 19 m/s, at most about 18 m/s, at most about 17 m/s, at most about 16 m/s, at most about 15 m/s, at most about 14 m/s, at most about 13 m/s, at most about 12 m/s, at most about 11 m/s, at most about 10 m/s, at most about 9 m/s, at most about 8 m/s, at most about 7 m/s, at most about 6 m/s, at most about 5 m/s, at most about 4 m/s, at most about 3 m/s, or at most about 2 m/s. This includes embodiments where the external surface of the target may be moving at velocities ranging from about 1 m/s to about 50 m/s along the direction of alignment, including, but not limited to, velocities ranging from about 10 m/s to about 45 m/s, and from about 15 m/s to about 40 m/s.

In some embodiments, the method may comprise rotating an electrospinning target having a substantially circular shape. In some embodiments, the method may comprise rotating the target at a frequency of at least about 250 rpm, such as at least about 300 rpm, at least about 350 rpm, at least about 400 rpm, at least about 450 rpm, at least about 500 rpm, at least about 550 rpm, at least about 600 rpm, at least about 650 rpm, at least about 700 rpm, at least about 750 rpm, at least about 775 rpm, at least about 800 rpm, at least about 825 rpm, at least about 850 rpm, at least about 875 rpm, at least about 900 rpm, at least about 925 rpm, at least about 950 rpm, at least about 975 rpm, at least about 1000 rpm, at least about 1025 rpm, at least about 1050 rpm, at least about 1075 rpm, at least about 1100 rpm, at least about 1125 rpm, at least about 1150 rpm, at least about 1175 rpm, at least about 1200 rpm, at least about 1225 rpm, at least about 1250 rpm, at least about 1275 rpm, at least about 1300 rpm, at least about 1325 rpm, at least about 1350 rpm, at least about 1375 rpm, at least about 1400 rpm, at least about 1425 rpm, at least about 1450 rpm, at least about 1475 rpm, at least about 1500 rpm, at least about 1550 rpm, at least about 1600 rpm, at least about 1650 rpm, at least about 1700 rpm, at least about 1750 rpm, at least about 1800 rpm, at least about 1900 rpm, at least about 2000 rpm, at least about 2100 rpm, at least about 2200 rpm, at least about 2300 rpm, or at least about 2400 rpm. In some embodiments, the method may comprise rotating the target at a frequency of at most about 2500 rpm, such as at most about 2400 rpm, at most about 2300 rpm, at most about 2200 rpm, at most about 2100 rpm, at most about 2000 rpm, at most about 1950 rpm, at most about 1900 rpm, at most about 1850 rpm, at most about 1800 rpm, at most about 1750 rpm, at most about 1700 rpm, at most about 1650 rpm, at most about 1600 rpm, at most about 1550 rpm, at most about 1500 rpm, at most about 1475 rpm, at most about 1450 rpm, at most about 1425 rpm, at most about 1400 rpm, at most about 1375 rpm, at most about 1350 rpm, at most about 1325 rpm, at most about 1300 rpm, at most about 1275 rpm, at most about 1250 rpm, at most about 1225 rpm, at most about 1200 rpm, at most about 1175 rpm, at most about 1150 rpm, at most about 1125 rpm, at most about 1100 rpm, at most about 1075 rpm, at most about 1050 rpm, at most about 1025 rpm, at most about 1000 rpm, at most about 975 rpm, at most about 950 rpm, at most about 925 rpm, at most about 900 rpm, at most about 875 rpm, at most about 850 rpm, at most about 825 rpm, at most about 800 rpm, at most about 775 rpm, at most about 750 rpm, at most about 725 rpm, at most about 700 rpm, at most about 600 rpm, at most about 500 rpm, at most about 400 rpm, or at most about 300 rpm This include embodiments comprising rotating the target at frequencies ranging from about 250 rpm to about 2500 rpm, including, but not limited to, frequencies ranging from about 500 rpm to about 2000 rpm, and from about 750 rpm to about 1500 rpm.

Electrospinning Fibers

As used herein, the term electrospinning refers generally to placing a high electric field between a polymer or polymer-composite solution and a conductive collector. This collector may be comprised of many different materials such as metals, conductive polymers or the like, and may take the form of a plate, a film, a filament, a rod etc. When an electric field strong enough to overcome the surface tension of the droplet is provided, a Taylor cone is formed. Following the creation of the Taylor cone, fibers are ejected toward the conductive collector. With this technique, many different polymers and polymer blends can be used to generate and spin fibers with various chemical compositions and to fabricate mats comprising the fibers without the aid of binders.

In some embodiments, the methods may comprise electrospinning a solution comprising a polymer to form a stationary phase comprising polymer nanofibers.

In some embodiments, the electrospinning step may be performed at an applied voltage of at least about 1 kV, such as at least about 2 kV, at least about 3 kV, at least about 4 kV, at least about 5 kV, at least about 6 kV, at least about 7 kV, at least about 8 kV, at least about 9 kV, at least about 10 kV, at least about 11 kV, at least about 12 kV, at least about 13 kV, at least about 14 kV, at least about 15 kV, at least about 16 kV, at least about 17 kV, at least about 18 kV, at least about 19 kV, at least about 20 kV, at least about 21 kV, at least about 22 kV, at least about 23 kV, at least about 24 kV, at least about 25 kV, at least about 26 kV, at least about 27 kV, at least about 28 kV, at least about 29 kV, at least about 30 kV, or at least about 40 kV. In some embodiments, the electrospinning step may be performed at an applied voltage of at most about 50 kV, such as at most about 40 kV, at most about 35 kV, at most about 30 kV, at most about 29 kV, at most about 28 kV, at most about 27 kV, at most about 26 kV, at most about 25 kV, at most about 24 kV, at most about 23 kV, at most about 22 kV, at most about 21 kV, at most about 20 kV, at most about 19 kV, at most about 18 kV, at most about 17 kV, at most about 16 kV, at most about 15 kV, at most about 14 kV, at most about 13 kV, at most about 12 kV, at most about 11 kV, at most about 10kV, or at most about 5 kV. This includes embodiments wherein the electrospinning step is performed at applied voltages ranging from about 1 kV to about 50 kV, including, but not limited to applied voltages ranging from 10 kV to about 30 kV, and from about 15 kV to about 25 kV.

In some embodiments, the electrospinning step may be performed at a flow rate of at least about 1 μL/min, such as at least about 5 μL/min, at least about 10 μL/min, at least about 11 μL/min, at least about 12 μL/min, at least about 13 μL/min, at least about 14 μL/min, at least about 15 μL/min, at least about 16 μL/min, at least about 17 μL/min, at least about 18 μL/min, at least about 19 μL/min, at least about 20 μL/min, at least about 21 μL/min, at least about 22 μL/min, at least about 23 μL/min, at least about 24 μL/min, at least about 25 μL/min, at least about 26 μL/min, at least about 27 μL/min, at least about 28 μL/min, at least about 29 μL/min, at least about 30 μL/min, at least about 35 μL/min, at least about 40 μL/min, at least about 45 μL/min, at least about 50 μL/min, at least about 60 μL/min, at least about 70 μL/min, at least about 80 μL/min, or at least about 90 μL/min. In some embodiments, the electrospinning step may be performed at a flow rate of at most about 100 μL/min, such as at most about 90 μL/min, at most about 80 μL/min, at most about 75 μL/min, at most about 70 μL/min, at most about 65 μL/min, at most about 60 μL/min, at most about 55 μL/min, at most about 50 μL/min, at most about 45 μL/min, at most about 40 μL/min, at most about 35 μL/min, at most about 30 μL/min, at most about 29 μL/min, at most about 28 μL/min, at most about 27 μL/min, at most about 26 μL/min, at most about 25 μL/min, at most about 24 μL/min, at most about 23 μL/min, at most about 22 μL/min, at most about 21 μL/min, at most about 20 μL/min, at most about 19 μL/min, at most about 18 μL/min, at most about 17 μL/min, at most about 16 μL/min, at most about 15 μL/min, at most about 14 μL/min, at most about 13 μL/min, at most about 12 μL/min, at most about 11 μL/min, at most about 10 μL/min, at most about 5 μL/min, or at most about 2 μL/min. This include embodiments wherein the electrospinning step is performed at flow rates ranging from about 1 μL/min to about 100 μL/min, including, but not limited to, flow rates ranging from about 5 μL/min to about 50 μL/min, and from about 10 μL/min to about 30 μL/min.

In some embodiments, the electrospinning step may be performed with a distance from the electrospinning tip to target of at least about 1 cm, such as at least about 2 cm, at least about 3 cm, at least about 4 cm, at least about 5 cm, at least about 6 cm, at least about 7 cm, at least about 8 cm, at least about 9 cm, at least about 10 cm, at least about 11 cm, at least about 12 cm, at least about 13 cm, at least about 14 cm, at least about 15 cm, at least about 16 cm, at least about 17 cm, at least about 18 cm, at least about 19 cm, at least about 20 cm, at least about 21 cm, at least about 22 cm, at least about 23 cm, at least about 24 cm, at least about 25 cm, at least about 26 cm, at least about 27 cm, at least about 28 cm, at least about 29 cm, at least about 30 cm, at least about 35 cm, at least about 40 cm, or at least about 45 cm. In some embodiments, the electrospinning step may be performed with a distance from the electrospinning tip to target of at most about 50 cm, such as at most about 45 cm, at most about 40 cm, at most about 35 cm, at most about 34 cm, at most about 33 cm, at most about 32 cm, at most about 31 cm, at most about 30 cm, at most about 29 cm, at most about 28 cm, at most about 27 cm, at most about 26 cm, at most about 25 cm, at most about 24 cm, at most about 23 cm, at most about 22 cm, at most about 21 cm, at most about 20 cm, at most about 19 cm, at most about 18 cm, at most about 17 cm, at most about 16 cm, at most about 15 cm, at most about 14 cm, at most about 13 cm, at most about 12 cm, at most about 11 cm, at most about 10 cm, at most about 5 cm, or at most about 2 cm. This includes embodiments wherein the electrospinning step is performed with a distance from the electrospinning tip to target ranging from about 1 cm to about 50 cm, including, but not limited to, distances ranging from about 5 cm to about 30 cm, and distances ranging from about 10 cm to about 20 cm.

In some embodiments, the electrospinning step may be performed for a length of time at least about 5 minutes, such as at least about 10 minutes, at least about 15 minutes, at least about 20 minutes, at least about 25 minutes, at least about 30 minutes, at least about 35 minutes, at least about 40 minutes, at least about 45 minutes, at least about 50 minutes, at least about 55 minutes, at least about 1 hour, at least about 2 hours, at least about 3 hours, at least about 4 hours, at least about 8 hours, or at least about 12 hours. In some embodiments, the electrospinning step may be performed for a length of time at most about 24 hours, such as at most about 12 hours, at most about 8 hours, at most about 7 hours, at most about 6 hours, at most about 5 hours, at most about 4 hours, at most about 3 hours, at most about 2 hours, at most about 1 hour, at most about 50 minutes, at most about 40 minutes, or at most about 30 minutes. This includes embodiments wherein the electrospinning step is performed for lengths of time ranging from about 5 minutes to about 8 hours, including, but not limited to, lengths of time ranging from about 10 minutes to about 4 hours, and ranging from about 30 minutes to about 3 hours.

Electrospinning Solutions

In some embodiments, the solution may comprise at least about 1 wt % polymer, such as at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt % polymer. In some embodiments, the solution may comprise at most about 50 wt % polymer, such as at most about 45 wt %, at most about 40 wt %, at most about 35 wt %, at most about 30 wt %, at most about 29 wt %, at most about 28 wt %, at most about 27 wt %, at most about 26 wt %, at most about 25 wt %, at most about 24 wt %, at most about 23 wt %, at most about 22 wt %, at most about 21 wt %, at most about 20 wt %, at most about 19 wt %, at most about 18 wt %, at most about 17 wt %, at most about 16 wt %, at most about 15 wt %, at most about 14 wt %, at most about 13 wt %, at most about 12 wt %, at most about 11, or at most about 10 wt % polymer. This included embodiments wherein the solution comprises from about 1 wt % to about 50 wt % polymer, including, but not limited to, from about 5 wt % to about 25 wt % polymer, and from about 7.5 wt % to about 15 wt % polymer.

### EXAMPLES

Exemplary embodiments of the present invention are provided in the following examples. The following examples are presented to illustrate the present invention and to assist one of ordinary skill in making and using the same. The examples are not intended in any way to otherwise limit the scope of the invention.

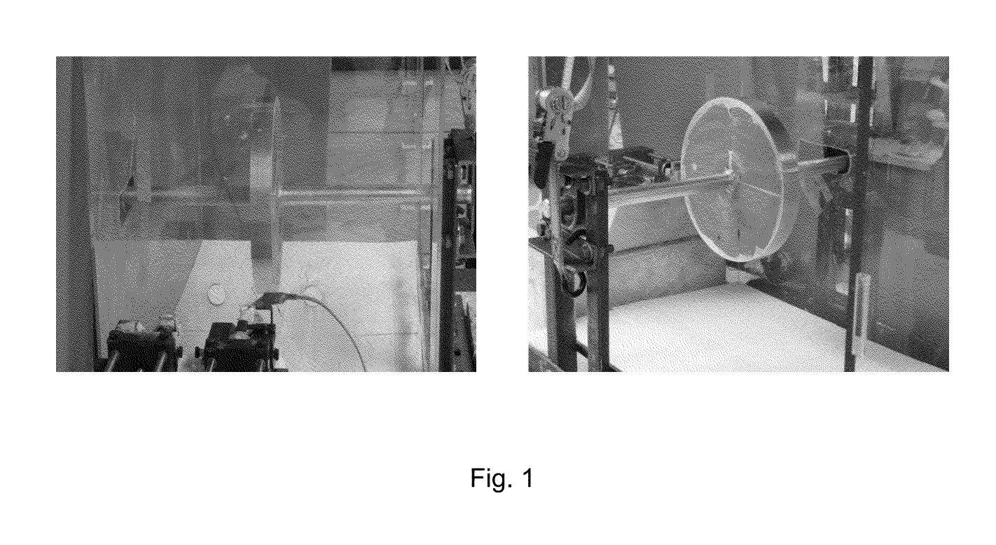

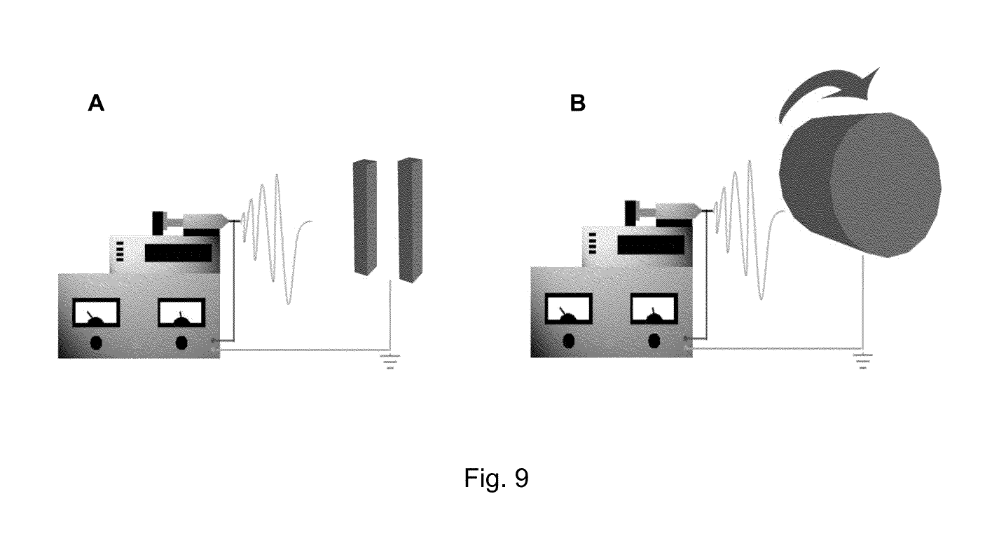

A photograph of the apparatus used for electrospinning is shown in FIG. 1 and a schematic is shown in FIG. 9B. Electrospinning solutions were prepared as described herein. A Spellman CZE 1000R high voltage power supply was used to supply voltages from 5 to 15 kV. A Harvard Model 33 dual syringe pump was used to control the flow rate of the electrospinning solutions. The flow rates were varied from 0 to 2 mL/min. Electrospinning experiments were performed while varying the following parameters: electrospinning solution concentrations, voltage, flow rate, and distance from the electrospinning tip to the target to determine the optimum parameters for production of fibers.

The spinning drum apparatus used in this experiment is shown in FIG. 1. The drum itself consisted of a 33.02 cm diameter×3.18 cm wide piece of aluminum, which was drilled out to reduce weight. The drum is supported by a bearing-containing support on each end via 27.94 cm axles. The supports are bolted to rails at the base; the rails were slotted to provide easy adjustment to meet electrospinning conditions. On one side, the mandrel was attached to a ¾ horsepower, air-actuated stirrer with a chuck (Mixer Direct, Inc., Jeffersonville, Ind.). This was used to rotate the drum relative to the electrospinning syringe. The motor was powered by house air, at a pressure of approximately 90 psi. The motor was capable of providing speeds of 0-3000 rpm; the rotational speed of the drum was determined using a NIST-certified, Monarch Instrument PLT200 pocket laser tachometer (Cole-Parmer, Vernon Hills, Ill.). During electrospinning experiments, the surface of the drum was wrapped with 0.003″ stainless steel shim stock (McMaster-Carr, Robbinsville, N.J.) to serve as a electrospinning target (solid support) for the nanofibers.

AE-UTLC plates were fabricated by removing the shim stock, now covered by aligned electrospun nanofibers, from the drum and cutting the material into plates that were appropriately sized for UTLC experiments (˜2×5 cm). Analytes were spotted on the plates utilizing a fused silica capillary with an internal diameter of 250 μm; the volume of analyte spotted was ˜50 nL. All UTLC experiments were conducted in a cylindrical glass development chamber (volume=250 mL) containing 5 mL of mobile phase. The equilibration time was 10 minutes. The development of the laser dyes was carried out with a 90:10 (v/v) 2-propanol:methanol mobile phase; the mixture of β-blockers and steroidal compounds were developed using a mobile phase composed of a mixture of chloroform and heptane with 1% w/w tetrabutylammonium bromide. All plates were developed until the mobile phase had reached a migration distance of 2.5 cm.

Following development, analysis was conducted utilizing a digital documentation system (Spectroline, Westbury, N.Y.). The system consists of a CC-81 cabinet fitted with an ENF-280C 365 nm/254 nm, 8 W UV lamp and a GL-1301 universal camera adapter with a 58 mm adapter ring. The camera that was utilized was a Canon A6501S 12.1 MP digital camera. Digital photographs were subsequently analyzed with ImageJ as well as TLC Analyzer (available at http:/www.sciencebuddies.org/science-research-paper/tlc_analyzer.shtml) (see, A. V. I. Hess, J. Chem. Educ. 84 (2007) 842-847, which is incorporated herein in its entirety by reference) and PeakFit. All images were darkened to enhance contrast prior to analysis. Analytes were visualized via exposure to UV radiation at λ=254 nm.

Polyacrylonitrile (PAN), molecular weight ˜150,000 g mol⁻¹, was purchased from Sigma Aldrich (Atlanta, Ga.). N,N-dimethylformamide, utilized as the solvent for PAN, was also purchased from Sigma Aldrich. The laser dyes studied were purchased from Exciton Inc. (Dayton, Ohio) and included kiton red, sulforhodamine 640, rhodamine 610 chloride, and rhodamine 610 perchlorate. Acebutolol, propranolol, and cortisone were purchased from Sigma Aldrich. Tetrabutylammonium bromide (99+%) was purchased from Arcos Organics (New Jersey). Acetone, heptane and 2-propanol were acquired from Fisher Scientific (Fair Lawn, N.J.). Chloroform (EMD Chemicals, Gibbstown, N.J.), ethanol (Decon Labs, Inc., King of Prussia, Pa.), and methanol (Avantor Performance Materials) were also utilized. Commercially available thin-layer chromatography plates were purchased from Macherey-Nagel (Bethlehem, Pa.) catalog number 818184. The plates contain a 0.15 mm layer on an aluminum sheet. The layer is composed of cyanopropyl modified silica particles ranging from 2-10 μm in size.

A Hitachi S-4300 (Hitachi High Technologies America, Inc., Pleasonton, Calif.) scanning electron microscope was utilized to obtain all the SEM images of the electrospun nanofibers. ImageJ (Available from the National Institute of Health at http://www.rsbweb.nih.gov/ij/index.html) software was employed for all measurements of SEM images, including those utilized to determine the degree of alignment of the electrospun nanofibers.

### Example 1

### UTLC Plates with Stationary Phases Having Aligned Nanofibers

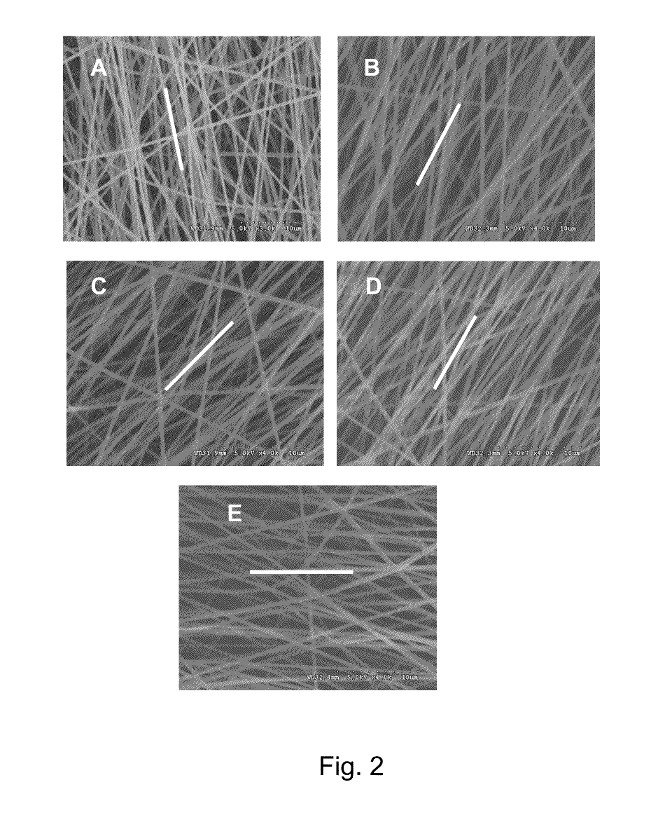

An initial study was performed to determine the degree of alignment of the electrospun PAN nanofibers that could be achieved with the rotating drum. Utilizing previously published parameters for generating electrospun PAN nanofibers (see, Clark (2009)), 30 minute electrospinning trials were performed at varying drum rotational speeds to determine optimum rotational speed of the drum for the production of highly aligned fibers. Experiments were performed at rotational speeds of 500, 750, 1000, 1250, and 1500 rpm in triplicate. FIG. 2 shows representative SEM images of the electrospun PAN nanofiber mats collected at each of these rotational speeds. The average nanofiber diameter was determined at each speed by measuring 45 individual nanofibers on each of three images for each run that was performed. The data in Table I illustrate that while the variance in nanofiber diameter from the lowest to the highest speed is less than 60 nm, there is a general trend toward decreasing nanofiber diameter with increasing rotational speed.

TABLE I

| Rotational Speed | Nanofiber Diameter |
|---|---|
| (rpm) | (nm) |
| 500 | 520 ± 70 |
| 750 | 480 ± 80 |
| 1000 | 480 ± 120 |
| 1250 | 450 ± 70 |
| 1500 | 470 ± 80 |

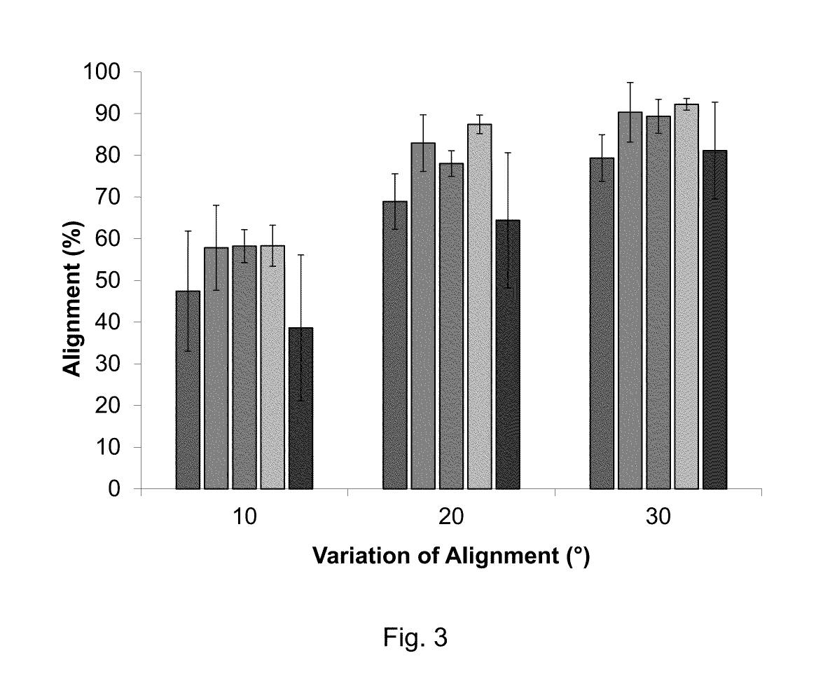

The alignment of the nanofibers at each rotational speed was also assessed using SEM images and ImageJ software. Using ImageJ, a virtual line was placed in the direction of alignment; the extent of the alignment was then assessed by determining the angle between the virtual line and individual nanofibers. The median of forty five replicate measurements from each of three trials was calculated for the nanofibrous mats collected at each rotational speed. The angle from which the electrospun nanofibers deviated from the direction of the alignment was quantified; the population of nanofibers that deviated by 10°, 20°, and 30° from the direction of alignment was then determined. See, M. B. Bazbouz, G. K. Stylios, J. Appl. Polym. Sci. 107 (2007) 3023-3032, which is incorporated herein in its entirety by reference. These measurements were performed for each of three images for three separate electrospun mats at each rotational speed. The results of these measurements are shown in FIG. 3. This same method was also applied to non-aligned electrospun PAN nanofibers collected on a stationary collector. In this case the virtual line was placed in the same direction as it had been for the aligned nanofibers. The virtual line could be overlaid in any direction on the SEM images of the non-aligned electrospun nanofibers and the same degree of alignment would be calculated as these nanofibers were randomly deposited upon the collector.

It is clear from FIGS. 2 and 3 that the alignment of the electrospun nanofibers collected at 500 and 1500 rpm is inferior relative to the alignment demonstrated for the nanofibers collected at 750, 1000, and 1250 rpm. Among the nanofibers collected at 750, 1000, and 1250 rpm, there is very little difference in their average alignment; for each of these three rotational speeds ˜60% of the nanofibers were within 10° of the direction of alignment, ˜80% of the nanofibers were within 20°, and over 90% of the electrospun nanofibers collected were within 30° of the direction of alignment. All nanofibrous mats collected on the rotating drum demonstrated a much higher degree of alignment than the non-aligned electrospun PAN nanofibers which were collected on a stationary collector. The non-aligned nanofibers had ˜20% of the nanofibers within 10° of each other, ˜30% of the nanofibers within 20°, and ˜45% of the electrospun nanofibers collected were within 30° of the same direction.

Ultimately, samples collected from 750-1250 rpms yielded good alignment; all chromatographic experiments were conducted utilizing electrospun nanofibrous mats collected at 1250 rpm. The 750 and 1000 rpm samples probably would have resulted in similar chromatographic performance to the 1250 rpm sample, however, the 1250 rpm was chosen as a slightly smaller standard deviation of the average fiber alignment between mats was observed.

The morphologies of the aligned electrospun PAN nanofibers and the non-aligned PAN nanofibers were further compared by assessing the degree to which the individual aligned and non-aligned nanofibers deviated from linearity via curving or twisting. In order to quantitatively compare both types of nanofibers, a tortuosity factor (TF) was calculated according to Equation 1 (see, W. Zhou, Y. Wu, F. Wei, G. Luo, W. Qian, Polymer, 46 (2005) 12689-12695, which is incorporated herein in its entirety by reference):

$$TF = \frac{Length of the curve line between two points}{Distance between two points} \qquad ( 1 )$$

All TF calculations were performed on SEM images of the same magnification (4000×) in order to ensure the scale at which the tortuosities of the nanofibers were determined was constant. The TF for the aligned nanofibers was determined to be 1.03±0.02; TF of the non-aligned nanofibers was 1.28±0.21. This indicates that the tortuosity of the non-aligned nanofibers was approximately 25% greater than that of the aligned nanofibers; it is clear that the alignment process not only orders the nanofibers by increasing the degree to which the nanofibers are collected in a single direction, but it also serves to straighten the individual nanofibers.

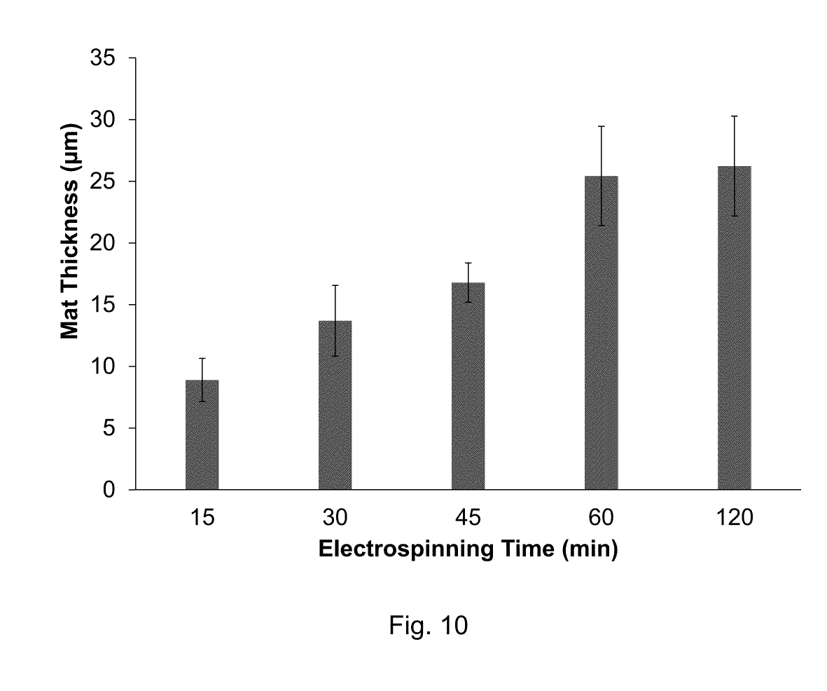

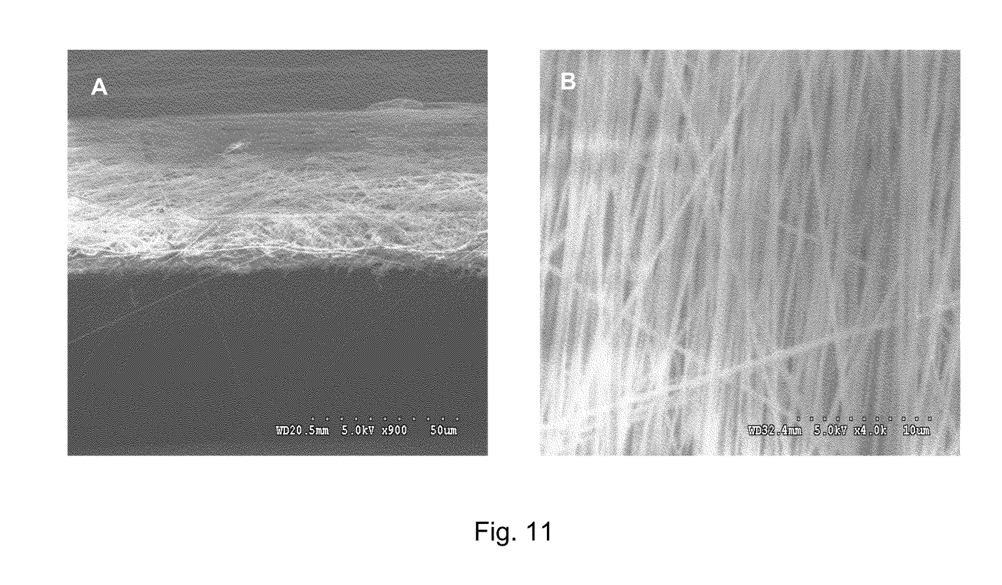

The effect of electrospinning time on mat thickness was also studied utilizing the same electrospinning parameters and maintaining the optimized collector rotational speed at ˜1250 rpm. Electrospun mats were generated at times of 5, 15, 30, 45, 60, and 120 minutes; the thicknesses of the mats were then determined using SEM and ImageJ software. FIG. 10 illustrates the relationship between electrospinning time and the thickness of the electrospun mat. Mat thickness increases with an increase in electrospinning time. However, it should be noted that after some time this increase deviates from linearity. While the mat thickness increases very little, remaining at ˜25 μm thick, the mass of the electrospun mat increases by nearly 100% when the electrospinning time is increased from 60 to 120 minutes. Similar behavior has also been observed when electrospinning to a stationary collector. See, Clark (2009). This suggests that while the thickness of the nanofibrous mat remains relatively unchanged, the nanofiber density of the mat increases. Initial experiments indicated that the aligned electrospun mats collected at lesser times, including the mat collected at 60 minutes, were of insufficient nanofiber density and demonstrated band broadening and poor chromatographic performance. As a result it was decided that the mat generated at an electrospinning time of 120 minutes would be utilized in this study. A representative SEM image of this mat is shown in FIG. 11. While the mass of the aligned electrospun mat collected at 60 minutes correlated strongly with the mass of the non-aligned electrospun mat generated with an electrospinning time of 20 minutes, no adequate separation could be obtained, necessitating the use of the nanofibrous mat collected at 120 minutes. As a consequence, while the mat thickness remains the same, the volume of the stationary phase, V_{S}, is greater for the AE-PAN plates than the E-PAN UTLC devices, demonstrating that a higher nanofiber density is required for the AE-PAN UTLC stationary phases. This suggests that the packing of the nanofibers is different for the aligned and non-aligned electrospun nanofibers.

In order to ensure that the alignment of the nanofibers had not been adversely affected by the increased electrospinning time, the alignment factor was recalculated using SEM images of the 120 minute, 1250 rpm mats. The alignment factor did not decrease with the increased electrospinning time (FIG. 11).

### Example 2

### AE-UTLC Phase Separation of Laser Dyes

In order to demonstrate the efficacy of using aligned electrospun nanofibers as a chromatographic stationary phase, a mixture of four laser dyes, rhodamine 610 chloride, rhodamine 610 perchlorate, sulforhodamine 640, and kiton red, was applied to the PAN AE-UTLC plates. The purpose of this separation was to establish the suitability of the AE-PAN nanofibers for separations. The retardation factor, R_{f} (Equation 2), for each of these compounds was calculated and is listed in Table II where the results are also compared to those for a PAN E-UTLC plate. Zₛ is the distance the analyte travels and Z_{f} is the distance the mobile phase travels during development. As previously noted, there is a wide range of chemical functionalities present within the selected laser dyes; it may not be possible to prepare a single mobile phase composition that is optimal for the separation of all of the analytes. See, Clark (2010).

$${R}_{f} = \frac{{Z}_{s}}{{Z}_{f}} \qquad ( 2 )$$

It is interesting to note that while there is no significant difference between the retardation factors observed for the laser dyes on the AE-UTLC plate versus the E-UTLC plate, the % RSD is generally lower (-50-80% lower for the four analytes) on the AE-UTLC plate.

TABLE II

| | AE-UTLC plate R_{f} | | E-UTLC plate R_{f} | |
|---|---|---|---|---|
| Analyte | (% RSD) | | (% RSD) | |
| Kiton red | 0.50 | (6.0) | 0.42 | (44) |
| Rhodamine 610 chloride | 0.30 | (19) | 0.51 | (39) |
| Rhodamine 610 perchlorate | 0.34 | (20) | 0.54 | (44) |
| Sulforhodamine 640 | 0.46 | (5.6) | 0.33 | (45) |

### Example 3

### AE-UTLC Phase Separation of β-Blockers and Steroidal Compounds

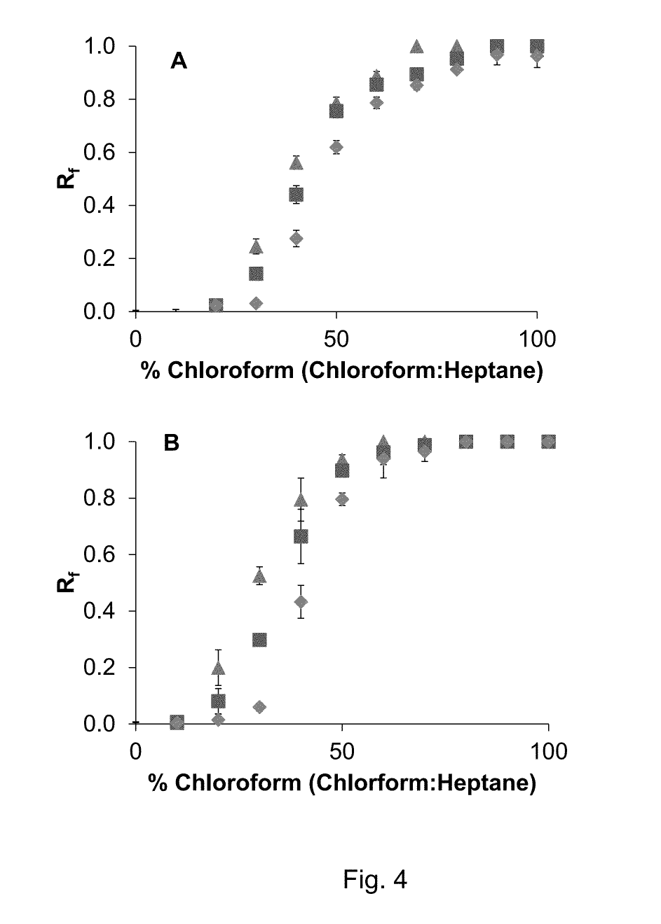

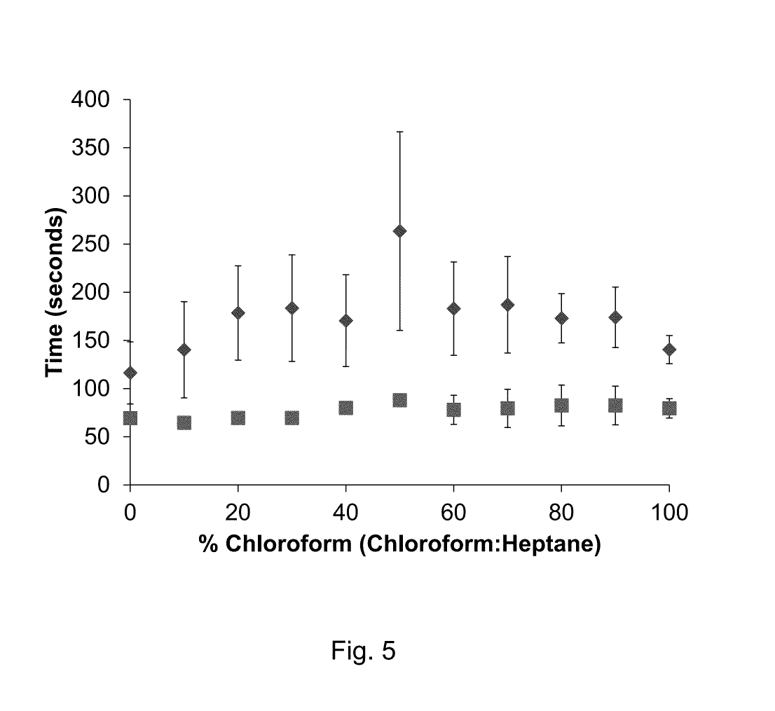

A mixture of acebutolol, propranolol, and cortisone was studied using both the PAN AE-UTLC and E-UTLC plates. The concentrations of the analytes were 2.5×10⁻³ M, 2.0×10⁻² M, and 5.0×10⁻³ M, respectively. These compounds represented the lowest concentrations that could be utilized while allowing for post-development visualization. The effects of changing the mobile phase composition on retention behavior were compared for both the PAN AE-UTLC (FIG. 4A) and E-UTLC (FIG. 4B) plates. A mobile phase comprised of a 40:60 (v/v) mixture of chloroform and heptane with 1% w/w tetrabutylammonium bromide (TBABr) was found to give the greatest resolution for the AE-UTLC plates, whereas a mobile phase consisting of a 30:70 (v/v) mixture of chloroform and heptane with 1% w/w TBABr gave the best resolution for the non-aligned E-UTLC plates. TBABr has been previously shown to decrease retention time while minimizing band broadening when applied to separations of analytes similar to acebutolol and propranolol. See, Jost (1986); and L. H. Bluhm, T. Li, J. Chromatogr. Sci. 37 (1999) 273-276, which is incorporated herein by reference in its entirety. When comparing FIGS. 4A and 4B, it is interesting to note that the AE-UTLC R_{f} plot is shifted to the right relative to the E-UTLC plot; the analytes begin to migrate sooner on the non-aligned UTLC plate than the AE-UTLC plate, despite the fact that the mobile phase velocity is faster for the AE-UTLC plate, as shown in FIG. 5.

The increased retention of the AE-UTLC plate can be explained by considering the increase in the volume of the stationary phase, V_{S}, for the AE-UTLC plates discussed earlier. Consider Equation 3 (see, Poole (2003)):

$$k = K \frac{{V}_{S}}{{V}_{M}} \qquad ( 3 )$$

where κ is the retention factor, K is the equilibrium constant, V_{M} is the mobile phase volume and V_{S} is the volume of the stationary phase. Since the stationary phase in the AE-UTLC and E-UTLC systems are comprised of PAN, K is the same for both plates. However, V_{S} is significantly greater for the AE-UTLC plate, which should give a corresponding increase in k. The retention factor, k, is further related to the retardation factor, R_{f}, according to Equation 4 (see, Poole (2003)).

$$k = \frac{1 - {R}_{f}}{{R}_{f}} \qquad ( 4 )$$

It is clear from Equation 4 that any increase in k would result in a decrease in R_{f,} this is observed in the case of the AE-UTLC plate. The increase in V_{S} for the AE-UTLC plate leads directly to the observed lower R_{f} values relative to the E-UTLC stationary phase.

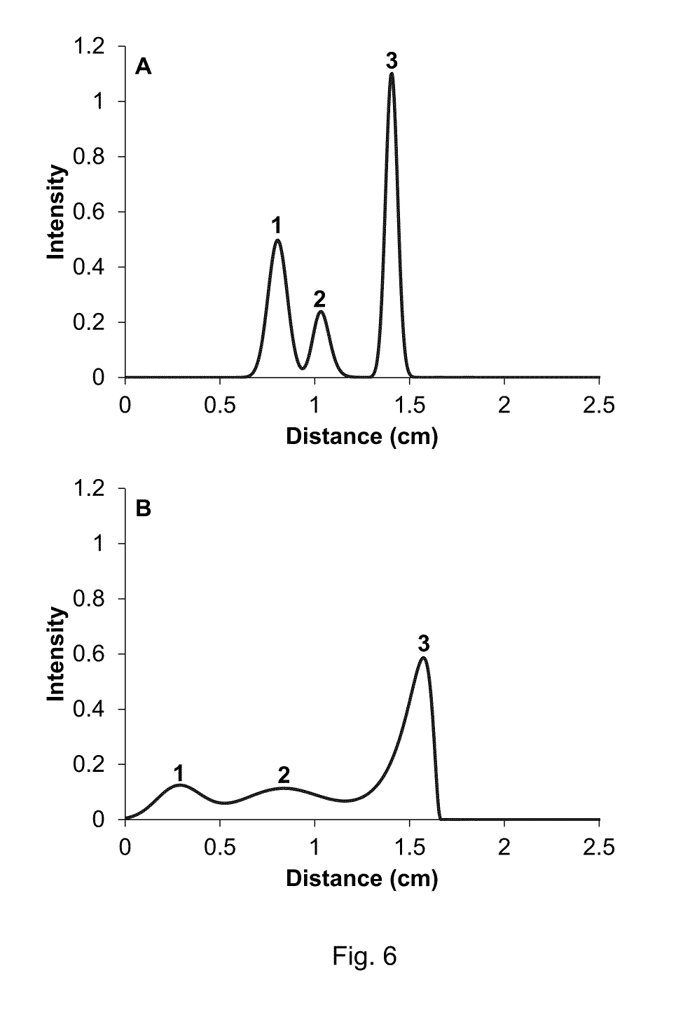

Sample chromatograms for the separation of the β-blocker/steroid mixture with PAN AE-UTLC and E-UTLC plates using chloroform and heptane mobile phases with 1% w/w TBABr is displayed in FIG. 6A-B. The resolution of the AE-UTLC plate was observed at 1.20 between acebutolol and cortisone as compared to 0.692 for the E-UTLC plate. Resolution was 2.02 and 1.01 between cortisone and propranolol for AE-UTLC and E-UTLC, respectively. Table III shows the optimized mobile phase conditions with respect to resolution for the AE-UTLC and E-UTLC chromatograms. The run-to-run reproducibility of the separation was enhanced with the AE-UTLC device, as noted by the smaller relative standard deviations of the R_{f} values for the analytes separated on the AE-UTLC plate compared to the E-UTLC plate. The AE-UTLC plates showed higher plate numbers for all three analytes when compared to the E-UTLC stationary phase at the conditions which gave the greatest resolution. Equation 5 was used to calculate plate number, N, which is proportional to the square of the migration distance of the analyte, Z_{S}, divided by the spot width of the developed analyte, w (see, Poole (2003)).

$$N = 16 {( \frac{{Z}_{S}}{w} )}^{2} \qquad ( 5 )$$

TABLE III

| | PAN AE-UTLC | | | PAN E-UTLC | | |
|---|---|---|---|---|---|---|
| | (40:60 chloroform:heptane) | | | (30:70 chloroform:heptane) | | |
| Analyte | N | R_{f} (% RSD) | | N | R_{f} (% RSD) | |
| Acebutolol | 470 | 0.27 | (11) | 3 | 0.06 | (24) |
| Cortisone | 130 | 0.44 | (6.7) | 36 | 0.30 | (6.6) |
| Propranolol | 1700 | 0.56 | (4.5) | 870 | 0.53 | (6.1) |

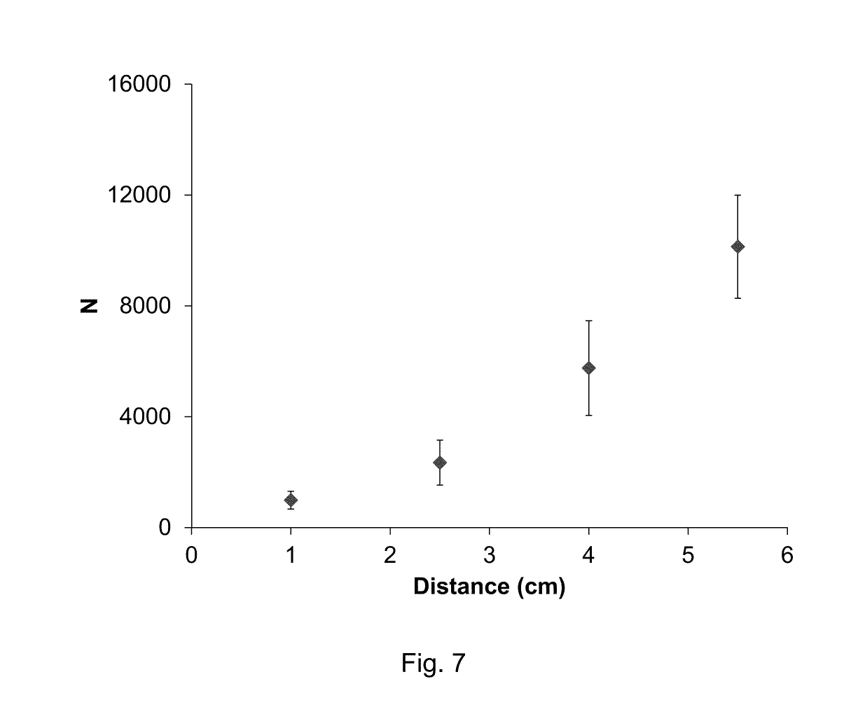

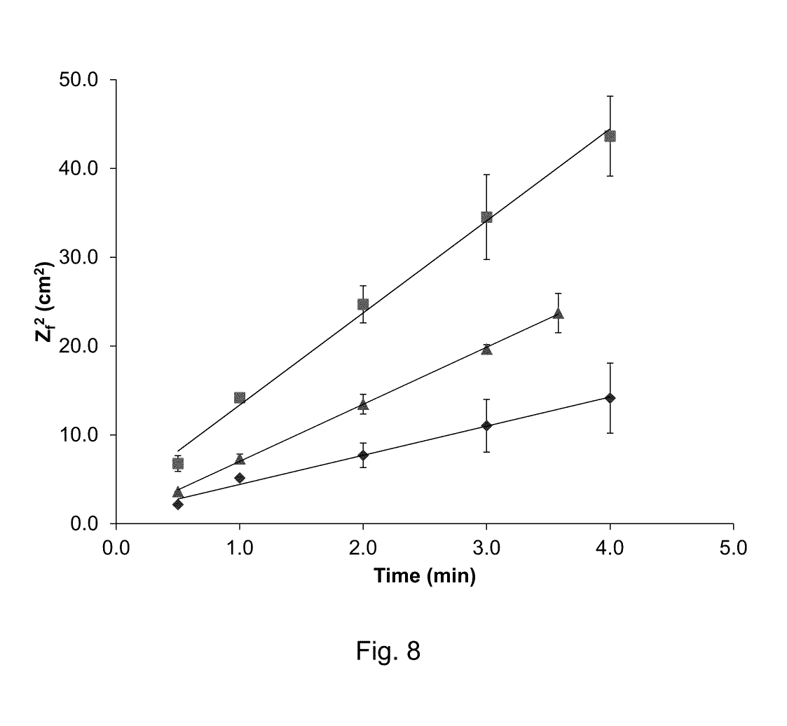

A single analyte, propranolol, was chosen to demonstrate the effect of longer migration distances on plate number calculations, as shown in FIG. 7. At longer development distances, N for propranolol was very high. The comparatively low plate numbers are a consequence of performing the separation at a relatively short migration distance of 2.5 cm. Increasing efficiency with increasing development distance was also observed for glassy carbon E-UTLC stationary phases (see, Clark (2010)); to our knowledge the only other reported occurrence of increased efficiency at increased migration distance involved the use of pressurized planar electrochromatography (PPEC). See, A. L. Novotny, D. Nurok, R. W. Replogle, G. L. Hawkins, R. E. Santini, Anal. Chem. 78 (2006) 2823-2830, which is incorporated herein in its entirety by reference. It is possible that this phenomenon is a result of multiple unique attributes of the AE-UTLC stationary phase. See, J. E. Clark, Unique Applications of Nanomaterials in Separation Science, Ph.D. thesis, the Ohio State University, Columbus, Ohio. 2010, which his incorporated herein in its entirety by reference. As discussed in greater detail below, the AE-UTLC plates demonstrate a very rapid mobile phase velocity (FIG. 5) which does not appear to slow significantly over distance and time (FIG. 8). Decreasing mobile phase velocity contributes greatly to band dispersion in TLC (see, Poole (2003)); as the mobile phase velocity rapidly decreases (typically at or before 7 cm in HPTLC) (see, C. F. Poole, S. K. Poole, J. Chromatogr. A. 703 (1995) 573-612, which is incorporated herein in its entirety by reference) the band broadening of the analyte exceeds its rate of migration (see, Poole (2003)). This causes a decrease in the quality of the separation and a decrease in N. See, Poole (2003); and Poole (1995). This effect could be mitigated by the higher mobile phase velocities of the AE-UTLC phase, resulting in higher N at increased migration distances. More detailed studies are being performed to further elucidate this chromatographic behavior.

As previously stated, FIG. 5 shows the times of analysis for both the PAN AE-UTLC and E-UTLC for a final migration distance of 2.5 cm as a function of mobile phase composition. It is clear that the PAN AE-UTLC plates not only provide a more rapid time of analysis, approximately 2-2.5 times faster than E-UTLC plates, but also a more reproducible time of analysis. This enhanced reproducibility in the time of analysis for the AE-UTLC plate causes enhanced reproducibility of the separation. Furthermore, these results demonstrate that AE-UTLC phases can be used to generate separations over a very small development distance in a short time frame. All AE-UTLC plates were developed between 1-1.5 minutes, compared to the nearly 3 minute analysis time for E-UTLC plates.

### Example 4

### Mobile Phase Velocity

As illustrated in Example 3, the AE-UTLC plates demonstrated significantly faster times of analysis relative to the E-UTLC plates showing that through alignment, the mobile phase velocity could be significantly increased. Mobile phase transport through electrospun nanofibrous mats in UTLC has been previously examined using the Lucas-Washburn equation (Equation 6). See, E. W. Washburn, Phys. Rev. 17 (1921) 374-375, which is incorporated herein in its entirety by reference.

$${Z}_{f}^{2} = \frac{γ Rt cos θ}{2 η} \qquad ( 6 )$$

In this equation, Z_{f} is the migration distance of the mobile phase, γ is the surface tension of the mobile phase, R is the effective capillary (or pore) radius, t is time, θ is the contact angle of the mobile phase with the stationary phase, and η is the mobile phase viscosity. See, Poole (2003); and Washburn (1921). The Lucas-Washburn equation is frequently used to describe capillary flow through porous substances, including traditional silica and cyano TLC stationary phases. The Lucas-Washburn equation can be applied assuming the following conditions: an adsorbed film of penetrating liquid must be present (accomplished by exposure to vapors of mobile phase and achievement of equilibrium prior to use); prevalence of laminar flow conditions (Reynolds number<1200); inertial influences must be negligible; the contact angle of the mobile face upon the stationary phase must be 0°. Nonpolar heptane has a 0° contact angle with the PAN and cyano phase surfaces and was employed as the mobile phase in the determination of R described below. The R of electrospun nanofibrous mats and its relationship on the rate of capillary rise has been previously studied; it was determined that as R increases the rate of capillary rise also increases. See, Clark (2010); and M. S. M. Jad, S. A. H. Ravandi, H. Tavanai, R. H. Sanatgar, Fiber Polym. 12 (2011) 801-807, which is incorporated herein in its entirety by reference.

The R of AE-UTLC plates was calculated using the Lucas-Washburn equation (Equation 6) and compared with R for both the E-UTLC and the commercial cyano TLC phases. The aligned PAN nanofibers had a calculated R of 1200±70 nm; this value is significantly larger than R for the non-aligned E-PAN nanofibers (280±10 nm) as well as the commercial cyano TLC phase (430±21 nm) (see, Clark (2010)). This is to be expected as the AE-UTLC phase demonstrates the highest mobile phase velocity (FIG. 8). It has been previously noted that the pore structure of E-UTLC plates greatly differs from that of traditional particle-based TLC stationary phases; R for the commercial cyano TLC phase is < 1/10 of the particle radius, whereas R for the non-aligned E-UTLC plate is ˜1.5 times greater than the nanofiber radius as measured by SEM, while the AE-PAN R is ˜5 times greater than the radius of the aligned PAN nanofibers. These results agree with the established trend of increasing mobile phase velocities with increasing values of R. However, inspection of the mat surface using SEM doesn't show physical pores of such large dimensions as 1200 nm. The measured effective pore radii with alignment was quite surprising.

When the Lucas-Washburn equation is applied to mobile phase migration in TLC, the velocity constant, κ, replaces the term γR/2. This factor has been traditionally used to describe mobile phase velocity in typical precoated TLC phases; κ relates Z_{f} and t according to Equation 7 (see, Poole (2003)):

Z_{f}=κt (7)

Plotting Z_{f}² versus t should give a straight line where κ is equal to the slope; deviations from a straight line are indicative of abnormal flow behavior resulting from experimental error or stationary phase irregularities. See, F. Geiss, Fundamentals of Thin Layer Chromatography (Planar Chromatography), Huethig, Heidelberg, Germany, Basel, Switzerland, New York, United States of America, 1987, which is incorporated herein in its entirety by reference. As shown in FIG. 8 these plots were compiled for the AE-UTLC, E-UTLC, and commercial cyano phases; κ was determined to be 0.173 cm² s⁻¹ for the AE-UTLC plates; this value is over 200% greater than that of the non-aligned E-UTLC plates (0.055 cm² s⁻¹). The commercial cyano phase, with average particle sizes of 2-10 μm, has a κ of 0.107 cm² s⁻¹. This corresponds directly to the faster mobile phase velocity observed for the PAN AE-UTLC plates. Additionally, FIG. 8 shows a linear relationship between Z_{f}² and t, demonstrating stationary phase homogeneity for the electrospun plates as well as verifying the applicability of the Lucas-Washburn equation for describing flow through electrospun media. The AE-UTLC plates demonstrated a κ value which is nearly 45% higher than that of the cyano plate.

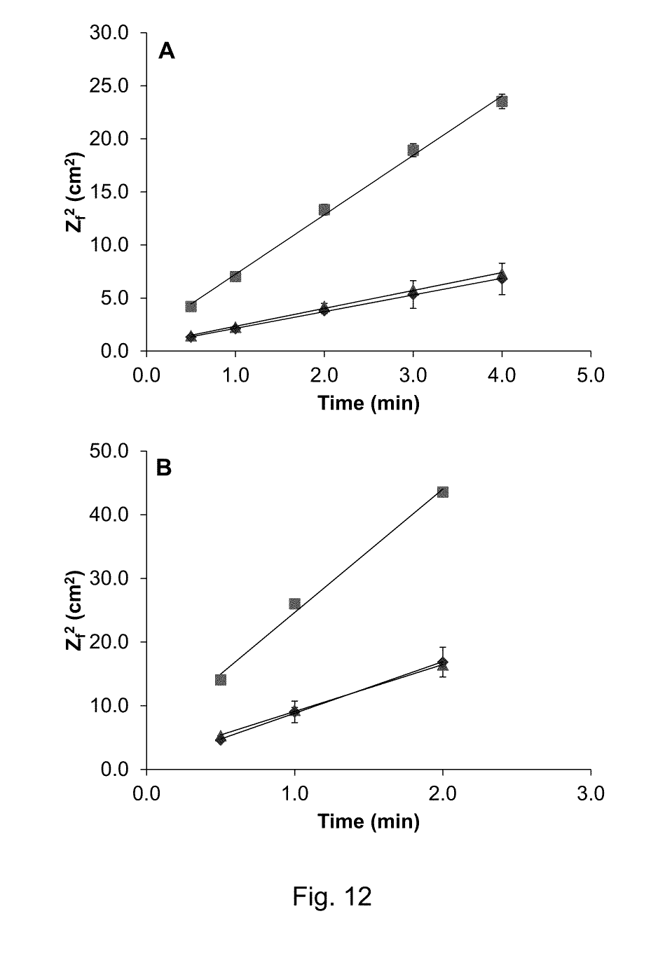

While the mobile phase velocity for the cyano plate is more rapid than that of the E-UTLC plate when heptane is used as the mobile phase (·90% faster) (FIG. 8), comparable mobile phase velocities are observed for the cyano and E-UTLC plates for acetone (E-UTLC ˜10% faster) and 50:50 acetone:water (cyano phase ˜5% faster) (FIG. 12A-B). The AE-UTLC plate showed faster mobile phase velocities than all other tested stationary phases for all mobile phase conditions. It is interesting that the ratio of mobile phase velocities between the different stationary phases is not constant across the studied solvent conditions; this is most dramatically illustrated by comparing the mobile phase velocities of the E-UTLC and cyano phases for heptane, acetone, and 50:50 acetone:water, detailed above. The Lucas-Washburn equation (Equation 5) suggests that the contact angle, θ, is changing to a different degree for the E-UTLC and cyano phases. For each mobile phase, γ and η are constant, while R is unchanged for each stationary phase; accordingly the observed difference in the value of Z_{f}²/t for the phases correlates directly with changes in θ. It has been previously noted that wetting of nanoscopic surfaces, and thus θ, can differ from the wetting of particles that possess diameters larger than 1 μm. As the sorbent particles become smaller (1-1000 nm) θ changes, as factors such as surface roughness and capillary size influence wetting behavior, and thus the mobile phase velocity, to a greater extent. See, K. M. Forward, A. L. Moster, D. K. Schwartz, D. J. Lacks, Langmuir, 23 (2007) 5255-5258, which is incorporated herein in its entirety by reference.

While it has been previously demonstrated that among electrospun UTLC plates, larger nanofiber diameters correspond with faster mobile phase velocity as well as increased values for R and κ, this explanation cannot be used to describe the increase of the mobile phase velocity of the AE-UTLC plates compared to the E-UTLC plates. See, Clark (2010). The nanofiber diameters of the AE-UTLC plates and E-UTLC plates (453±70 nm vs. 400±50 nm) are not statistically different at the 95% confidence level. This suggests that the more highly aligned structure of the AE-UTLC nanofibrous mat, as well as the decreased tortuosity of the nanofibers, are primarily responsible for the observed enhancement in mobile phase velocity relative to the E-UTLC stationary phases. These results strongly corroborate previous studies which demonstrate that increased nanofiber tortuosity decreases R and thus also decreases the rate of capillary rise of liquids penetrating the nanofibrous mat (see, Jad (2011)).

The electrospun UTLC devices described herein proved to be chemically and mechanically robust over a large number of experiments. Each plate was used for at least 3-15 trials before performance or physical structure diminished. After the plates were no longer usable, the nanofiber stationary phase was simply removed by scrubbing the substrate and then cleaned with acetone. A new device for UTLC could then be created by electrospinning onto the reusable substrate.

What is claimed is:

1. An ultrathin-layer chromatography plate including a stationary phase comprising electrospun nanofibers wherein at least about 50% of the nanofibers are oriented within 20° of a direction of alignment, and wherein the stationary phase has a thickness from about 10 μm to about 30 μm.

2. The ultrathin-layer chromatography plate of claim 1, wherein the nanofibers comprise a polymer selected from the group consisting of polyacrylonitrile, polyvinyl alcohol, polyacrylamide, poly(methyl methacrylate), polyethylene oxide, polyvinylpyrrolidone, sodium polystyrene sulfonate, polyhydroxyalkanoate, polystyrene, SU-8 photoresist, nylon, and combinations thereof.

3. The ultrathin-layer chromatography plate of claim 1, wherein the nanofibers have an average diameter from about 250 nm to about 750 nm.

4. The ultrathin-layer chromatography plate of claim 1, wherein the nanofibers have an average diameter from about 300 nm to about 500 nm.

5. The ultrathin-layer chromatography plate of claim 1 having an average effective pore radius from about 1.00 μm to about 2.00 μm.

6. The ultrathin-layer chromatography plate of claim 1 having a mobile phase velocity constant along the direction of alignment of at least one of the following:
greater than about 0.150 cm²s⁻¹ for heptane as mobile phase;
greater than about 0.050 cm²s⁻¹ for a 50:50 mixture of acetone and water as mobile phase; and
greater than about 0.150 cm²s⁻¹ for acetone as mobile phase.

7. The ultrathin-layer chromatography plate of claim 1, wherein the stationary phase has a length and a width, and the thickness of the stationary phase is substantially consistent along its entire length and width.

8. A method of making an ultrathin-layer chromatography plate including a stationary phase comprising electrospun nanofibers wherein at least about 50% of the nanofibers are oriented within 20° of a direction of alignment, the method comprising:
rotating an electrospinning target having a substantially cylindrical structure; and
electrospinning a solution comprising a polymer to form the stationary phase comprising polymer nanofibers, the stationary phase having a thickness from about 10 μm to about 30 μm.

9. The method of claim 8, wherein an external surface of the target is moving at a velocity of from about 1 m/s to about 50 m/s along the direction of alignment.

10. The method of claim 8, wherein the target is rotating at about 250 rpm to about 2500 rpm.

11. The method of claim 8, wherein the target is rotating at about 750 rpm to about 2000 rpm.

12. The method of claim 8, wherein the electrospinning step is performed for a length of time from about 10 minutes to about 2 hours.

13. The method of claim 8, wherein the electrospinning step is performed with at least one of the following:
an applied voltage from about 1 kV to about 50 kV;
a flow rate of about 1 μL/min to about 100 μL/min; and
a distance from the electrospinning tip to target from about 1 cm to about 50 cm.

14. The method of claim 8, wherein the nanofibers comprise a polymer selected from the group consisting of polyacrylonitrile, polyvinyl alcohol, polyacrylamide, poly(methyl methacrylate), polyethylene oxide, polyvinylpyrrolidone, sodium polystyrene sulfonate, polyhydroxyalkanoate, polystyrene, SU-8 photoresist, nylon, and combinations thereof.

15. The method of claim 8, wherein the nanofibers have an average diameter from about 250 nm to about 750 nm.

16. The method of claim 8, wherein the nanofibers have an average diameter from about 300 nm to about 500 nm.

17. The method of claim 8, wherein the ultrathin-layer chromatography plate has an average effective pore radius from about 1.00 μm to about 2.00 μm

18. The method of claim 8, wherein the ultrathin-layer chromatography plate has a mobile phase velocity constant along the direction of alignment of at least one of the following:
greater than about 0.150 cm²s⁻¹ for heptane as mobile phase;
greater than about 0.050 cm²s⁻¹ for a 50:50 mixture of acetone and water as mobile phase; and
greater than about 0.150 cm²s⁻¹ for acetone as mobile phase.

19. The method of claim 8, wherein the solution comprises about 1 wt % to about 50 wt % polymer.

20. The method of claim 8, wherein the solution comprises about 5 wt % to about 20 wt % polymer.
